(19) United States
(12) Patent Application Publication
(10) Pub. No.: US 2001/0026149 A1
(43) Pub. Date: Oct. 4, 2001

(54) Voltage regulator circuit and method of driving voltage regulator circuit

(76) Inventor: Yoshihide Kanakubo, Chiba-shi (JP)

Correspondence Address: ADAMS & WILKS, 31st Floor, 50 Broadway, New York, NY, 10004, US

(21) Appl. No.: 09/778,238

(22) Filed: Feb. 7, 2001

(30) Foreign Application Priority Data
Mar. 31, 2000 (JP) 2000-98573

(51) Int. Cl. G05F 1/40

(52) U.S. Cl. 323/284

(57) ABSTRACT

When a power supply of a voltage regulator turns on, and when a load rapidly fluctuates, overshoot occurring at an output terminal voltage is reduced by using an output transistor lower in driving capability.

### BACKGROUND OF THE INVENTION

1. Field of the Invention

The present invention relates to a voltage regulator capable of improving overshoot of the voltage regulator.

2. Description of the Related Art

As a conventional voltage regulator, there has been known a voltage regulator shown in FIG. 4. An output voltage of a reference voltage circuit 1 and a voltage resulting from dividing a voltage of an output terminal 4 by resistors 5 and 6 are compared with each other by an error amplifying circuit 2, to thereby control an output transistor 3 on the basis of an output result.

If the voltage resulting from dividing the voltage of the output terminal 4 by the resistors 5 and 6 is smaller than the output voltage of the reference voltage circuit 1, an output of the error amplifying circuit 2 becomes small and the output transistor 3 is strongly biased, thereby making the voltage of the output terminal 4 large. Conversely, if the voltage resulting from dividing the voltage of the output terminal 4 by the resistors 5 and 6 becomes larger than the output voltage of the reference voltage circuit 1, the output transistor 3 is weakly biased, thereby making the output terminal voltage small. In this manner, the voltage of the output terminal 4 is kept constant.

However, in the conventional voltage regulator, because the voltage resulting from dividing the voltage of the output terminal 4 by the resistors 5 and 6 is smaller than the output voltage of the reference voltage circuit 1 at the time of turning on a power supply, the output of the error amplifying circuit 2 becomes small and the output transistor 3 is strongly biased with the result that the voltage of the output terminal 4 is going to rapidly rise up to a given voltage. In this situation, since the voltage of the output terminal 4 rapidly rises, even if the voltage of the output terminal 4 exceeds the desired constant voltage, because a reaction of the error amplifying circuit is slow as compared with a rising speed of the voltage of the output terminal voltage 4, the voltage of the output terminal 4 is kept to the desired constant voltage a certain period of time after the output terminal voltage 4 exceeds the desired constant voltage.

As described above, because the voltage of the output terminal 4 more rapidly changes as a difference between the voltage of the output terminal 4 and the desired constant voltage to be outputted from the output terminal 4 is larger, there arises such a problem in that a certain period of time elapses after the output terminal voltage 4 exceeds the desired constant voltage, resulting in that the constant output voltage cannot be outputted which is a main object of the voltage regulator.

### SUMMARY OF THE INVENTION

The present invention has been made to solve the above problem with the conventional voltage regulator, and therefore an object of the present invention is to reduce overshoot by making an output terminal gently rising up to a desired constant voltage without rapidly rising, by using an output transistor low in driving capability from an error amplifying circuit of a voltage regulator when a voltage difference between an output of the output terminal and the desired constant voltage is large.

In order to achieve the above object, according to the present invention, there is provided a voltage regulator in which an output transistor portion has two or more transistors different in driving capability, thereby being capable of reducing overshoot at the time of starting or when there is a large difference between a voltage of an output terminal and a desired constant voltage.

According to the present invention, when there is a large difference between a voltage of an output terminal and a desired constant voltage, an output transistor lower in driving capability is used to reduce overshoot.

### BRIEF DESCRIPTION OF THE DRAWINGS

These and other objects, features and advantages of this invention will become more fully apparent from the following detailed description taken with the accompanying drawings in which:

FIG. 1 is a diagram for explanation of a voltage regulator in accordance with an embodiment of the present invention;

FIG. 2 is a diagram showing the outline of a switching circuit in accordance with the embodiment of the present invention;

FIG. 3 is a diagram showing a specific example of the switching circuit in accordance with the embodiment of the present invention; and

FIG. 4 is a diagram for explanation of a conventional voltage regulator.

### DETAILED DESCRIPTION OF THE PREFERRED EMBODIMENTS

Now, a description will be given in more detail of a preferred embodiment of the present invention with reference to the accompanying drawings.

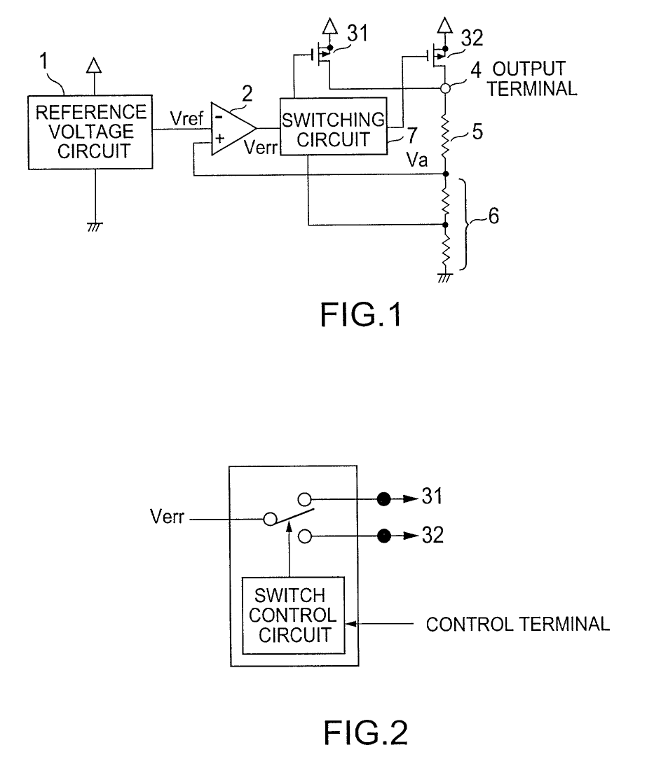

FIG. 1 is a diagram showing a voltage regulator circuit in accordance with the embodiment of the present invention. A reference voltage circuit 1, an error amplifying circuit 2 and resistors 5 and 6 are identical with those in the conventional voltage regulator.

In the figure, an output of the error amplifying circuit 2 is connected to an input of a switching circuit 7, and outputs of the switching circuit 7 are connected to an output transistor 31 higher in driving capability and an output transistor 32 lower in driving capability, respectively.

The internal circuit of the switching circuit 7 is shown in brief in FIG. 2. The specific operation of the switching circuit 7 is that when the voltage of an output terminal 4 is lower than an arbitrary set voltage, because there is a large difference between the voltage of the output terminal 4 and a desired constant voltage to be outputted from the voltage regulator, the voltage of the output terminal 4 is made to gently rise up to the desired constant voltage by using the output transistor 32 lower in the driving capability.

Then, when the voltage of the output terminal 4 becomes higher than the arbitrary set voltage, the output transistor 31 higher in the driving capability is used by the switching circuit 7.

As described above, since the output transistors are selectively used, even if a load slightly fluctuates during a normal operation, the output transistor 31 higher in the driving capability is used so as to always keep the voltage of the output terminal 4 constant.

Also, at the time of turning on a power supply and at the time of recovery from a load short-circuit, the output transistor 32 lower in the driving capability is used, to thereby make the voltage of the output terminal 4 gently rise, thus reducing the overshoot.

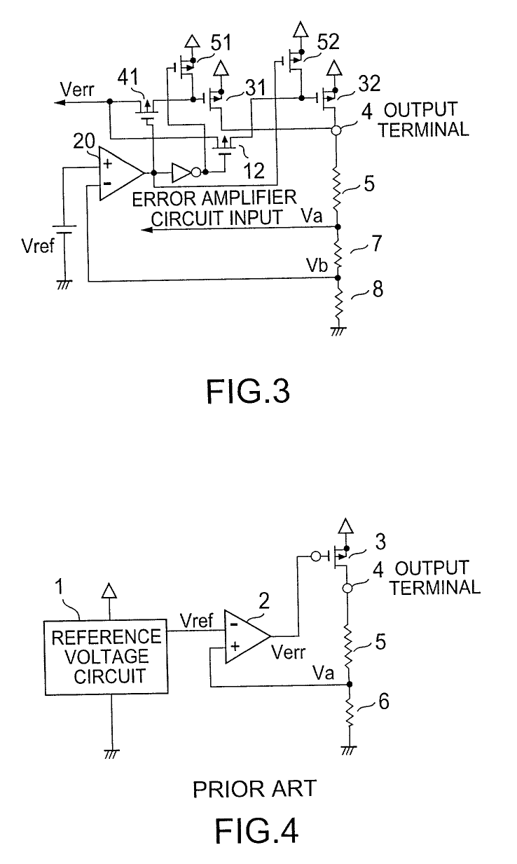

A specific circuit example of the switching circuit 7 is shown in FIG. 3. The minus input of a comparator 20 is inputted with an output voltage Vb divided by a resistor, and the plus input of the comparator 20 is inputted with a reference voltage output Vref. If the voltage of Vb is lower than Vref, the output of the comparator 20 becomes “H”, an SW Tr 42 turns on, and an output Verr of the error amplifying circuit is connected to the output transistor 32 lower in the driving capability. Also, when the voltage of vb is higher than Vref, the output of the comparator 20 becomes “L”, an SW Tr 41 turns on, and the output transistor 31 higher in the driving capability turns on. In FIG. 3, transistors 51 and 52 are transistors that conduct pull-up operation in order to prevent the gates of the transistors 31 and 32 from floating.

This embodiment is performed under the conditions where Va is inputted to the plus input of the error amplifying circuit and Vb that satisfies Va>Vb is inputted to the minus input of the comparator 20.

As described above, when the voltage Vb resulting from dividing the voltage of the output terminal 4 by the resistors 5 and 6 is lower than Vref, that is, at the time of turning on the power supply or at the time of recovery from the load short-circuit, the transistor lower in the driving capability is used, to thereby reduce the overshoot.

As was described above, according to the present invention, since two or more output transistors different in the driving capability are provided in the voltage regulator, the output is maintained to a constant voltage by using the output transistor higher in the driving capability during the normal operation even when the load fluctuates, and the overshoot can be reduced by using the output transistor lower in the driving capability at the time of starting or when there is a large difference between the output terminal and the desired constant voltage.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A regulator circuit, comprising:
a reference voltage source;
an error amplifying circuit that inputs one of a reference voltage and an output of the reference voltage; and
an output transistor portion controlled by an output of said error amplifying circuit;
wherein said output transistor portion has two or more switchable transistors different in driving capability.

2. A regulator circuit as claimed in claim 1, wherein a first output transistor and a second output transistor higher in driving capability than said first output transistor are connected to an output of said error amplifying circuit that compares the output voltage of a reference voltage circuit with a voltage resulting from dividing the voltage of an output terminal by a first resistor and a second resistor in parallel with the output terminal through a switching circuit.

3. A regulator circuit as claimed in claim 2, wherein said switching circuit drives said first output transistor when the voltage of said output terminal is lower than a set voltage and drives said second output transistor when the voltage of said output terminal is higher than the set voltage.

4. A method of driving a regulator circuit in which a first output transistor and a second output transistor higher in driving capability than said first output transistor are connected to an output of an error amplifying circuit that compares the output voltage of a reference voltage circuit with a voltage resulting from dividing the output of an output terminal by a first resistor and a second resistor in parallel with the output terminal through a switching circuit, wherein said switching circuit drives said first output transistor when the voltage of said output terminal is lower than a set voltage to thereby make the voltage of said output terminal gently rise.
